(19) United States
(12) Patent Application Publication
(10) Pub. No.: US 2023/0286376 A1
(43) Pub. Date: Sep. 14, 2023

(54) GEAR UNIT FOR A VEHICLE AND POWERTRAIN WITH SUCH A GEAR UNIT

(71) Applicant: ZF FRIEDRICHSHAFEN AG, Friedrichshafen (DE)

(72) Inventor: Thomas KÖLBL, Ruderting (DE)

(21) Appl. No.: 18/180,387

(22) Filed: Mar. 8, 2023

(30) Foreign Application Priority Data
Mar. 10, 2022 (DE) 10 2022 202 380.3

(51) Int. Cl. B60K 17/08; B60K 1/00; B60K 17/16

(52) U.S. Cl. CPC B60K 17/08; B60K 1/00; B60K 17/16; B60K 2001/001

(57) ABSTRACT

A gear unit has a differential with two planetary gearsets and gearset elements. A first gearset element of the first planetary gearset is connected to an input shaft, a second gearset element of the first planetary gearset is connected to a first output shaft, a third gearset element of the first planetary gearset is connected to a first gearset element of the second planetary gearset, a second gearset element of the second planetary gearset is connected to a housing, and a third gearset element of the second planetary gearset is connected to a second output shaft. A first output torque is transmittable to the first output shaft. A second output torque is transmittable to the second output shaft. An actuation mechanism is arranged between the first and second output shafts for a co-rotationally fixed connection between the output shafts when the actuation mechanism is actuated.

### BACKGROUND OF INVENTION

### 1. Field of the Invention

The disclosure is directed to a gear unit for a powertrain of a vehicle and to a powertrain with such a gear unit.

### 2. Description of Related Art

DE 10 2019 205 750 A1 discloses a gear unit comprising an input shaft, a first output shaft, a second output shaft, a first planetary gearset, and a second planetary gearset connected to the first planetary gearset. The planetary gearsets comprise a plurality of elements in each instance, the input shaft, the two output shafts, the planetary gearsets and elements thereof being arranged and formed in such a way that a torque introduced by the input shaft is converted and divided in a defined ratio between two output shafts. In so doing, the formation of a sum torque is prevented. At least one element of the first planetary gearset is connected to another element of the second planetary gearset to be fixed with respect to rotation relative to it, and a further element of the secondary planetary gearset is secured to a structural component that is fixed with respect to relative rotation.

It is known in differentials, for example, bevel gear differentials or spur gear differentials, to utilize preloaded bearing surfaces or sliding surfaces to generate a blocking effect. This is known, e.g., from DE 10 2011 085 119 B3.

### SUMMARY OF THE INVENTION

An object of one aspect of the present invention is a gear unit for a powertrain with a blocking function. It is a further object of one aspect of the invention to provide a powertrain with such a gear unit.

A gear unit according to one aspect of the invention for a powertrain of a vehicle comprises an input shaft, a first output shaft, a second output shaft, and an integral differential operatively arranged between the input shaft and the two output shafts. The differential comprises a first planetary gearset with a plurality of gearset elements and a second planetary gearset with a plurality of gearset elements operatively connected to the first planetary gearset. A first gearset element of the first planetary gearset is connected to the input shaft to be fixed with respect to rotation relative to it, a second gearset element of the first planetary gearset is connected to the first output shaft to be fixed with respect to rotation relative to it, and a third gearset element of the first planetary gearset is connected to a first gearset element of the second planetary gearset to be fixed with respect to rotation relative to it. A second gearset element of the second planetary gearset is connected to a stationary structural component to be fixed with respect to rotation relative to it, and a third gearset element of the second planetary gearset is connected to the second output shaft to be fixed with respect to rotation relative to it. A first output torque is at least indirectly transmittable to the first output shaft by the first planetary gearset. A reaction torque of the first planetary gearset can be converted in the second planetary gearset in such a way that a second output torque corresponding to the first output torque is transmittable to the second output shaft. An actuation mechanism having at least one positive engagement element is operatively arranged between the first output shaft and second output shaft. The respective positive engagement element is formed to produce a co-rotationally fixed connection between the two output shafts when the actuation mechanism is actuated.

In such a gear unit, the sums of both wheel torques are not unified or combined to form a common axle torque in a component part. Instead, the propulsion power introduced into the input shaft is divided in the integral differential and, corresponding to the construction and connection of the planetary gearsets, is conveyed to the output shafts which are operatively connected to the latter. Therefore, the component parts of the integral differential can be formed slimmer because of the comparatively small torque. Further, the quantity of component parts and weight are reduced. Consequently, a gear unit is provided in which, by the integral differential, the two functions of torque conversion and torque distribution as well as a blocking effect which were previously carried out by separate assemblies can be performed by an individual integral assembly. Accordingly, the invention relates to a combined transmission/differential gear unit which realizes a torque conversion on the one hand and distributes torque to the output shafts on the other hand. In addition, a power splitting is realized.

Within the framework of this invention, an integral differential is understood as a differential with a first planetary gearset and with a second planetary gearset that is operatively connected to the first planetary gearset The first planetary gearset is drivingly connected to the input shaft, to the second planetary gearset and at least indirectly to the first output shaft. Further, the second planetary gearset is drivingly connected to the second output shaft and is supported at a stationary structural component. By an integral differential of this kind, the input torque at the input shaft can be converted and can be distributed or transmitted to the two output shafts in a defined ratio. Preferably, 50%, that is, one half, of the input torque is transmitted to each output shaft.

The input shaft, the two output shafts, the planetary gearsets and gearset elements thereof are arranged and formed in such a way that a torque introduced via the input shaft is converted in the differential and divided between the two output shafts in a defined ratio. Accordingly, the differential has no component part to which the sum of the two output torques is applied. In other words, a sum torque is prevented. Further, at identical output speeds of the output shafts, the differential has no direct-driving teeth or teeth revolving without rolling motion. Consequently, irrespective of the output speeds of the output shafts, there is always a relative movement of the component parts of the differential which are in meshing engagement with one another. The output shafts of the gear unit are configured in particular to be operatively connected to a wheel of the vehicle. The respective output shaft can be connected to the associated wheel directly or indirectly, that is, via a joint and/or a wheel hub, for example.

Consequently, the integral differential is constructed as a planetary gear unit with planetary gearsets and gearset elements comprising sun gear, ring gear and a plurality of planet gears guided by a planet carrier on an orbit around the sun gear.

By “planetary gearset” is meant a unit having a sun gear, a ring gear and one or more planet gears guided by a planet carrier on an orbit around the sun gear, the planet gears being in meshing engagement with the ring gear and the sun gear. At least some of the gearset elements, preferably all of the gearset elements, of the planetary gearsets may be formed as spur gears or helical gears.

The input shaft is preferably adapted to be connected to a drive unit, particularly an electric machine or an internal combustion engine, for introducing a torque into the gear unit. The input shaft is accordingly connected at least indirectly to a driveshaft of the drive unit to be fixed with respect to rotation relative to it. The drive unit generates a propulsion power which is transmitted to the input shaft via the driveshaft. The driveshaft of the drive unit can be connected to the input shaft to be fixed with respect to rotation relative to it. Alternatively, the driveshaft and the input shaft constitute a cohesive or integral component part. Depending on the construction of the powertrain, two or more input shafts can be provided, particularly when the powertrain is a hybridized powertrain and, therefore, two or more drive units are provided.

The input shaft is preferably formed as a hollow shaft. The input shaft is preferably adapted for radially receiving the first coupling shaft. In other words, the first coupling shaft is guided through the input shaft. Accordingly, the first coupling shaft is guided through the gear unit “in-line”, so to speak, in order to transmit a propulsion power to the wheel that is operatively connected to it. Accordingly, the output shafts can advantageously be arranged coaxial to one another. As a result of the coaxial arrangement of the output shafts, a radially narrow construction of the gear unit can be realized.

A “shaft” is understood as a rotatable component part of the gear unit via which associated components of the gear unit are connected to one another to be fixed with respect to relative rotation. The respective shaft can connect the components axially or radially or both axially and radially. The term “shaft” does not apply exclusively, for example, to a cylindrical, rotatably supported machine element for transmitting torque. On the contrary, it can also refer to common connecting elements which connect individual component parts or elements to one another, in particular to connection elements which connect a plurality of elements to one another to be fixed with respect to relative rotation.

In principle, the planetary gearsets of the gear unit, in particular of the integral differential, may be arranged relative to one another and operatively connected to one another in any manner in order to realize a desired transmission ratio. According to an embodiment example, the first gearset element is a sun gear of the respective planetary gearset, the second gearset element is a planet carrier of the respective planetary gearset, and the third gearset element is a ring gear of the respective planetary gearset. The input shaft is accordingly connected to the sun gear of the first planetary gearset to be fixed with respect to rotation relative to it, the planet carrier of the first planetary gearset is connected to the first output shaft to be fixed with respect to rotation relative to it, and the ring gear at the planetary gearset is at least indirectly connected to the sun gear of the second planetary gearset to be fixed with respect to rotation relative to it. In particular, the ring gear of the first planetary gearset is connected via a coupling element, particularly a coupling shaft, to the sun gear of the second planetary gearset to be fixed with respect to rotation relative to it. According to an embodiment example according to the first aspect of the invention, the planet carrier of the second planetary gearset is connected to a stationary component part, particularly a gear unit housing, to be fixed with respect to rotation relative to it, and the ring gear of the second planetary gearset is connected to the second output shaft to be fixed with respect to rotation relative to it.

Further, additional component parts, for example, intermediate shafts or coupling shafts, can be arranged between the above-mentioned component parts, i.e., the gearset elements of the planetary gearsets, analogous to the above-mentioned coupling shafts.

The first planetary gearset and second planetary gearset are preferably adjacently arranged in axial direction. In other words, the gearset elements of the first planetary gearset are arranged in a first common plane and the gearset elements of the second planetary gearset are arranged in a second common plane, the two planes extending substantially parallel and being arranged axially adjacent to one another. The respective common plane is oriented substantially perpendicular to the respective axle of the vehicle.

Alternatively, the first planetary gearset and second planetary gearset are arranged to be radially nested. A radially nested construction of the integral differential is realized in that the first planetary gearset according to the first aspect of the invention is arranged at least in some areas radially inside of the second planetary gearset. In other words, the gearset elements of the first planetary gearset and second planetary gearset are arranged axially in a common plane. Consequently, the first planetary gearset and second planetary gearset are arranged substantially in a common wheel plane, for which reason the gear unit may be designed to be axially short and therefore particularly compact. Accordingly, the first planetary gearset and second planetary gearset are arranged one above the other viewed radially.

One of the planetary gearsets or both of the planetary gearsets of the differential are preferably formed, respectively, as negative planetary gearset or as positive planetary gearset. A negative planetary gearset corresponds to a planetary gearset with a planet carrier on which first planet gears are rotatably mounted, and with a sun gear and a ring gear, the teeth of at least one of the planet gears meshing with the teeth of the sun gear and also with the teeth of the ring gear so that the ring gear and the sun gear rotate in opposite directions when the sun gear rotates with fixed carrier. A positive planetary gearset differs from the negative planetary gearset in that the positive planetary gearset has first and second, or inner and outer, planet gears which are rotatably mounted on the planet carrier. The teeth of the first, or inner, planet gears mesh with the teeth of the sun gear on the one hand and with the teeth of the second, or outer, planet gears on the other hand. Further, the teeth of the outer planet gears mesh with the teeth of the ring gear. As a result, with the planet carrier being fixed, the ring gear and the sun gear rotate in the same direction.

When one or both planetary gearsets are formed as positive planetary gearset, the connection of the planet carrier and ring gear is switched and the amount of the stationary gear ratio is increased by one. In the same sense, the reverse is also possible if a negative planetary gearset is to be provided instead of a positive planetary gearset. The connection between the ring gear and the planet carrier would then be switched compared to the planetary gearset, and a stationary gear ratio would be reduced by one and the mathematical sign would change. However, the two planetary gearsets are preferably constructed as negative planetary gearsets within the framework of the invention. Negative planetary gearsets have a high degree of efficiency and can be arranged axially side by side or radially nested.

Alternatively, it is also conceivable to form one or both planetary gearsets as stepped planetary gearsets. Each stepped planet gear of the respective stepped planetary gearset preferably comprises a first toothed wheel with a second toothed wheel connected to it to be fixed with respect to relative rotation. The first toothed wheel is in meshing engagement, for example, with the sun gear, and the second toothed wheel is correspondingly in meshing engagement with the ring gear, or vice versa. These two toothed wheels may be connected to one another to be fixed with respect to relative rotation, for example, via an intermediate shaft or a hollow shaft. In case of the later, this hollow shaft can be rotatably mounted on a pin of the planet carrier. The two toothed wheels of the respective stepped planet gear preferably have different diameters and numbers of teeth in order to adjust a transmission ratio. Moreover, combined planetary gearsets are also contemplated.

In the present case, a gear unit is provided that can perform the functions of torque conversion, torque distribution and blocking effect between the output shafts through an individual integral subassembly. Accordingly, inter alia, a gear unit with an integral differential is provided which enables a 100% blocking effect independent from torque and rotational speed. This can be achieved in both pull and push operation. In particular, the blocking effect is independent from an input torque of the gear unit, The blocking effect is controllable and adjustable via the actuation mechanism depending on the driving situation or operating situation. To this end, the actuation mechanism can communicate with a control unit in a suitable manner.

The blocking effect of the gear unit is achieved by a blocking torque which is generated by actuation of the actuation mechanism with resulting positively engaging connection between the output shafts. The blocking action is not dependent upon torque or speed; that is, it can be carried out at any time during operation of the motor vehicle. A “blocking value” is the quotient of the difference between the two output torques and the sum of the two output torques. A 100% percent blocking effect means a co-rotationally locking, i.e., slip-free, connection between the output shafts. In other words, the output shafts are blocked from rotating relative to one another. With a blocking effect of zero, there is no co-rotationally locking connection between the output shafts, that is, with a blocking effect of 0%, both wheels have exactly the same torque. With a blocking value of 100%, one output transmits 100% of the torque and the other transmits zero.

The above-mentioned blocking function is realized by actuating or activating the actuation mechanism. The actuation mechanism can comprise an actuator or be an actuator which, when energized, controlled and/or adjusted in a corresponding manner, actuates the respective positive engagement element for the at least indirectly co-rotationally fixed connection of the output shafts, in particular sets the respective positive engagement element in axial and/or radial movement. The actuation of the actuation mechanism can comprise, for example, a permanent energizing of an actuator, particularly of an electric motor, until the blocking effect is to be deactivated again. Alternatively, a limited-time or temporary energizing can be carried out for actuating the actuation mechanism. The differential is free from load during the actuation of the actuation mechanism, i.e., before and while the positive engagement is produced. It is only after the positive engagement has been produced, i.e., when a 100% blocking effect has been produced, that a torque can again be introduced to the differential for driving the wheels of the vehicle which are operatively connected to the output shafts.

The first output shaft and second output shaft are connectable to one another to be fixed with respect to relative rotation via the respective positive engagement element. Depending on the construction of the actuation mechanism, the respective positive engagement element can be displaced in such a way that the positive engagement is produced between the output shafts. In this connection, “actively” means that the torque-transmitting connection between the output shafts is carried out by controlling an actuator, or the like, which actuates or activates the actuation mechanism.

The respective positive engagement element is preferably a claw which is at least indirectly arranged at the second output shaft to be fixed with respect to relative rotation and axially displaceable and has a first face toothing, the claw being adapted to axially displace in such a way when the actuation mechanism is actuated that the first face toothing comes in meshing engagement with a second face toothing which is at least indirectly arranged at the first output shaft.

The respective claw can be connected to the second output shaft to be fixed with respect to rotation relative to it and axially guided. Alternatively, the respective claw can be connected to the third gearset element of the second planetary gearset, for example, the second ring gear of the second planetary gearset, to be fixed with respect to rotation relative to it and axially guided at this third gearset element. As a further alternative, the third gearset element of the second planetary gearset can be connected via an intermediate shaft to the second output shaft to be fixed with respect to rotation relative to it. In this case, the respective claw is conceivably connected to the intermediate shaft to be fixed with respect to rotation relative to it and is axially guided at the latter.

A reverse arrangement is also contemplated. In this case, the respective positive engagement element is a claw which is at least indirectly arranged at the first output shaft to be fixed with respect to rotation and actually displaceable relative to it and has a first face toothing which is adapted to displace axially when the actuation mechanism is actuated such that the first face toothing comes in meshing engagement with a second face toothing which is at least indirectly arranged at the second output shaft. The examples and advantages mentioned above apply in a corresponding manner.

The respective claw can be fastened to a driver which is operatively connected to an actuator of the actuation mechanism. In this case, the actuator is configured to actuate the respective claw with the first face toothing in such a way that it is displaced in axial direction until it engages with the second face toothing. The second face toothing can be formed directly on the second output shaft. Alternatively, the second face toothing can be formed at a flange or the like which is connected to the second output shaft to be fixed with respect to rotation relative to it. The respective positive engagement element is preferably at least indirectly arranged at the first output shaft to be fixed with respect to rotation relative to it via the driver. In other words, the respective positive engagement element is at least indirectly supported at the first output shaft in circumferential direction via the driver.

By “axial” is meant within the meaning of the invention an orientation in direction of a longitudinal central axis along which the planetary gearsets and the output shafts are arranged to extend coaxial to one another. By “radial” is meant an orientation in diameter direction of a shaft extending on this longitudinal central axis.

In an alternative embodiment form, a first radial toothing is formed at least indirectly at the respective positive engagement element. Depending on the construction of the actuation mechanism, this first radial toothing is inserted in or slipped over a second radial toothing formed in a complementary manner at the respective output shaft. To this effect, the teeth are formed as driving teeth producing a co-rotationally fixed connection between the output shafts.

There is preferably provided a plurality of positive engagement elements arranged to be distributed on a common ring. In particular, there is provided a plurality of claws arranged to be distributed, in particular uniformly distributed, at the ring or formed thereon. The claws and the ring can be formed integrally or monolithically. Alternatively, the claws can also be secured to the ring, for example, by a screw connection and/or welded connection. Corresponding to the preceding constructions for the at least indirect co-rotationally fixed and axially guided arrangement of the respective claw at the first output shaft, the ring can also be arranged co-rotationally fixed and axially displaceably at least indirectly at the first output shaft, for example, directly at the first output shaft, at the third gearset element or an intermediate shaft arranged therebetween. By the ring, the positive engagement elements are combined together with the ring to form an actuation element by which the co-rotationally fixed connection between the output shafts can be produced.

The actuation mechanism can be formed in any desired manner in principle. In every case, it is formed in such a way that, when it is actuated, the respective positive engagement element produces a co-rotationally fixed connection between the output shafts. The actuation mechanism is preferably an electromagnetic actuator, a hydraulic actuator or an electromechanical actuator.

An electromechanical actuator can comprise an electric machine. An electric machine of this kind can comprise at least one co-rotationally fixed stator and a rotatably mounted rotor which is adapted to convert electrical energy into mechanical energy in the form of rotational speed and torque during motor operation and, if necessary, to convert mechanical energy into electrical energy in the form of current and voltage during generator operation. By energizing the electric machine, the actuation element, in this case, the respective positive engagement element, can be brought at least indirectly into positive engagement with the two output shafts. For example, the electromechanical actuator can have two circular disks with ramp-shaped ball running paths, a plurality of balls being arranged in the ball running paths between the circular disks. The axial distance between the circular disks can be adjusted by rotating at least one of the circular disks relative to the other so that a displacement of the respective positive engagement element is carried out for realizing the positive engagement between the output shafts.

A hydraulic actuator can comprise a cylinder-piston system. The piston, which is displaceable inside of the cylinder, limits a first working chamber and second working chamber. By alternately filling the first working chamber and the second working chamber with a fluid under pressure, for example, a hydraulic fluid, the piston which is operatively connected to the positive engagement element can be displaced in axial direction thus bringing the respective positive engagement element into or out of engagement with the second face toothing. It would also be conceivable to use a pneumatic actuator. In that case, the fluid is compressed air.

A preferred electromagnetic actuator comprises at least one, preferably two, electromagnets through which extends a plunger or armature which is connected at one axial end at least indirectly to the respective positive engagement element so that the axial, oscillating motion of the plunger directly brings about a corresponding movement of the respective positive engagement element. To this effect, the respective claw or claws and/or the ring are formed from a magnetic material. When the magnet or magnets are correspondingly activated or energized, the electromagnetic actuator magnetically interacts with the respective claw and/or ring in order to displace the respective claw and/or the ring with the claws arranged thereon in direction of the second face toothing. As long as the respective electromagnet is energized, the respective positive engagement element is held in its position in which the co-rotationally fixed connection between the output shafts is maintained.

The actuation mechanism preferably has a reset mechanism for resetting the respective claw and/or the ring to an initial position. The actuation mechanism with reset mechanism is suitable particularly for an actuation mechanism formed as electromagnetic actuator, the actuator comprising a monostable electromagnet which can only displace in one axial direction when the respective positive engagement element is energized. The resetting of the respective positive engagement element is carried out via the reset mechanism, in particular comprising at least one return spring, when the electromagnet is deactivated or de-energized. A reset mechanism can also be provided for an electromotor actuator acting, for example, on the described circular disks in order to displace the latter back into their initial position. A functional reliability of the gear unit can be ensured by the reset mechanism.

When the actuation mechanism is a hydraulic actuator, the reset mechanism can be omitted because the hydraulic actuator can actively generate and actively cancel a positive engagement because of the two fillable working chambers.

The ring is preferably formed to interact with a sensor unit in order to acquire the axial position of the ring. For example, with an actuation mechanism formed as electromagnetic actuator, it may be necessary to determine the position of the plunger as exactly as possible to position it exactly. To this end, targets may be provided at the plunger and the positions of the targets can be determined by correspondingly configured sensors.

If an element is fixed, in particular to the stationary structural component, it is prevented from rotational movement. The structural component of the gear unit that is fixed with respect to relative rotation can preferably be a permanently stationary component, preferably a housing of the gear unit, a portion of such a housing or a structural component connected to the latter to be fixed with respect to rotation relative to it.

Within the framework of the invention, two structural components of the gear unit being “connected” or “coupled” or “communicating with one another” to be co-rotationally fixed means that these structural components are permanently coupled such that they cannot rotate independently from one another. Accordingly, an enduring rotational connection is meant. In particular, there is no switching element or shifting element provided between these structural components, which latter can be elements of the differential and/or also shafts and/or a co-rotationally fixed structural component of the gear unit. Rather, the corresponding structural components are fixedly coupled with one another. A torsionally elastic connection between two component parts also means that these components are fixed or co-rotationally fixed. In particular, a co-rotationally fixed connection can also include joints, e.g., in order to make possible a steering movement or a deflection of a wheel.

The term “operatively connected” means a non-shiftable connection between two component parts which is provided for a permanent transmission of a propulsion power, particularly a rotational speed and/or a torque. The connection can be made directly or via a fixed transmission. The connection can be carried out, for example, via a fixed shaft, gear teeth, particularly a spur gear toothing, and/or a belt mechanism.

By “at least indirectly” is meant that two component parts are (operatively) connected to one another via at least one further component part which is arranged between these two component parts or are directly and thus immediately connected to one another. Consequently, there can be arranged between shafts or toothed wheels further component parts which are operatively connected to the shaft or toothed wheel.

According to a second aspect of the invention, a powertrain according to the invention for a vehicle comprises a gear unit according to the previous constructions and a drive unit which is operatively connected to the gear unit. The drive unit is preferably an electric machine. The input shaft of the gear unit is a rotor of the electric machine or is connected to or coupled with the rotor or a rotor shaft to be fixed with respect to rotation relative to it. The rotor is rotatably mounted relative to a stator of the electric machine, this stator being fixed with respect to the housing. The electric machine is preferably connected to an accumulator which supplies the electric machine with electrical energy. Further, the electric machine is preferably controllable or adjustable by power electronics. Alternatively, the drive unit can also be an internal combustion engine. In this case, the input shaft is a crankshaft, for example, or is connected to or coupled with a crankshaft to be fixed with respect to rotation relative to it.

The drive unit is preferably arranged coaxial to the integral differential. Accordingly, an additional transmission from the input shaft to the rotor shaft or the rotor or crankshaft of the drive unit is not required.

The drive unit is preferably formed as an electric machine and is arranged coaxial to the input shaft, the first output shaft being guided through a rotor of the electric machine. Accordingly, the gear unit is particularly compact. Further, the first output shaft is guided through the input shaft.

Further intermediately connected components formed, for example, as planetary gear unit, spur gear unit, chain drive, belt drive, angle drive, articulated shaft, torsional damper, multispeed gearbox, or the like, may be arranged between the input shaft and the drive unit. Also, further intermediately connected components such as, for example, articulated shafts, step-up gear units, spring elements and damping elements, or the like, may be arranged between the respective output shaft and the wheel which is operatively connected thereto.

In particular, a step-up gear unit or a multispeed gear unit, preferably a two-speed transmission, can additionally be arranged upstream of the gear unit. This step-up gear unit or multispeed gear unit can then also be a component part of the gear unit and used to configure an additional multiplication in that, for example, the speed of the prime mover is stepped up and the input shaft is driven at this stepped-up speed. In particular, the multispeed gear unit or step-up gear unit can take the form of a planetary transmission.

The powertrain according to the type described above is utilizable in a vehicle. The vehicle is preferably a motor vehicle, in particular an automobile (e.g., a passenger vehicle with a weight of less than 3.5 t), bus or truck (bus and truck, e.g., with a weight of more than 3.5 t). In particular, the vehicle is an electric vehicle or a hybrid vehicle. The vehicle comprises at least two axles, one of the axles forming a drive axle which is drivable by the powertrain. The powertrain according to the invention is operatively arranged at this driving axle. The powertrain transmits a propulsion power of the drive unit to the wheels of this axle via the gear unit according to the invention. It is also conceivable for each axle to be provided with a powertrain of this type. The powertrain is preferably a front transverse type construction so that the input shaft and the output shafts are oriented substantially transverse to the longitudinal direction of the vehicle. Alternatively, the powertrain can be arranged diagonal to the longitudinal axis and transverse axis of the vehicle, in which case the output shafts are connected via corresponding joints to the wheels of the respective axle which are arranged transverse to the longitudinal axis of the vehicle.

The above definitions and statements relating to technical effects, advantages and advantageous embodiment forms of the inventive gear unit according to the first aspect of the invention apply analogously to the inventive powertrain according to the second aspect of the invention, and vice versa.

### BRIEF DESCRIPTION OF THE DRAWINGS

An embodiment example of the invention will be explained more fully in the following referring to the schematic drawings. The drawings show:

FIG. 1 a highly schematic top view of a vehicle with a powertrain according to the invention and a gear unit according to the invention in a first embodiment form; and

FIG. 2 a highly schematic diagram of the gear unit according to the invention from FIG. 1 with an actuation mechanism in the unactuated state;

FIG. 3 a schematic longitudinal section through the gear unit according to the invention from FIG. 2 with the actuation mechanism in the unactuated state;

FIG. 4 a highly schematic diagram of the gear unit according to the invention according to FIG. 1 to FIG. 3 in the actuated state of the actuation mechanism; and

FIG. 5 a schematic longitudinal section through the gear unit according to the invention from FIG. 4 in the actuated state of the actuation mechanism.

### DETAILED DESCRIPTION OF THE PRESENTLY PREFERRED EMBODIMENTS

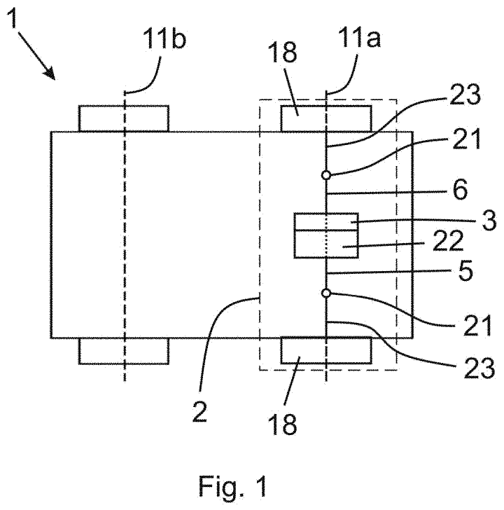

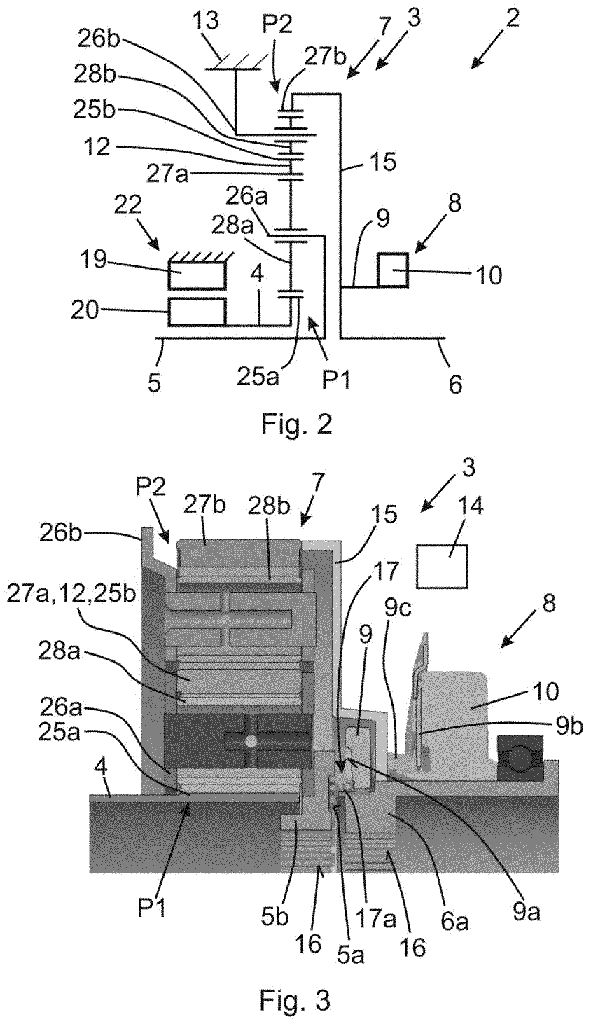

FIG. 1 shows a vehicle 1 with two axles 11a, 11b. A powertrain 2 according to the invention is drivingly arranged at the first axle 11a. The first axle 11a may be a front axle or rear axle of the vehicle 1 and forms a driven axle of the vehicle 1. Further, it is conceivable that the second axle 11b also has a powertrain 2 according to the invention. The powertrain 2 comprises a drive unit 22 constructed as an electric machine and a gear unit 3 which is operatively connected to the latter. The construction and the arrangement of the powertrain 2 in the vehicle 1, in particular the gear unit 3, will be explained in more detail in the following figures. An exemplary drive unit 22 is shown in FIG. 1 and FIG. 2. This will be omitted in the following figures for the sake of simplicity. Only an input shaft 4 is shown, this input shaft 4 being drivingly connected to the drive unit 22 for transmitting a torque into the gear unit 3. The electric machine is supplied with electrical energy by an accumulator—not shown—which is operatively connected to a stator 19, shown in FIG. 2, which is fixed with respect to the housing. Further, the electric machine is connected to power electronics—not shown—for controlling and adjusting. By energizing the stator 19 of the electric machine, a rotor 20 which is arranged to be rotatable relative to the stator 19 and which is in turn connected as drive shaft to the input shaft 4 of the gear unit 3 to be fixed with respect to rotation relative to it is set in rotational motion relative to the stator 19. Alternatively, the input shaft 4 can also be connected to or coupled with a separate rotor shaft of the rotor 20 to be fixed with respect to rotation relative to it. Accordingly, the propulsion power of the drive unit 22 is guided via the input shaft 4 into the gear unit 3, where it is converted by an integral differential 7 and at least indirectly divided between a first output shaft 5 and a second output shaft 6. The drive unit 22 comprising the stator 19 and the rotor 20 is arranged coaxial to the integral differential 7.

The output shafts 5, 6, which are arranged coaxial to one another are indirectly connected in each instance to a wheel 18, shown in FIG. 1, of the first axle 11a in order to drive the vehicle 1. Joints 21 and wheel hubs 23 are arranged between the respective wheel 18 and the output shafts 5, 6 in order to compensate possible tilting of the output shafts 5, 6. Consequently, the vehicle 1 is an electric vehicle, and the drive is carried out fully electrically.

FIGS. 2 to 5 show a preferred embodiment of the gear unit 3 in two different states, which will be explained in the following. The respective gear unit 3 is a differential gear and in the present instance comprises the input shaft 4, a first output shaft 5 and a second output shaft 6. The output shafts 5, 6 are arranged coaxial to the integral differential 7 and extend in opposite directions toward the wheels 18 proceeding from the gear unit 3. In the present instance, the first output shaft 5 extends toward the left-hand side and the second output shaft 6 extends toward the right-hand side.

The integral differential 7 has a first planetary gearset P1 with a plurality of gearset elements and a second planetary gearset P2 which is operatively connected to the latter and which also has a plurality of gearset elements. In the present instance, at the first planetary gearset P1, the first gearset element is a first sun gear 25a, the second gearset element is a first planet carrier 26a, and the third gearset element is a first ring gear 27a. A plurality of first planet gears 28a in meshing engagement with the first sun gear 25a and the first ring gear 27a are rotatably arranged at the first planet carrier 26a. Further, at the second planetary gearset P2, the first gearset element is a second sun gear 25b, the second gearset element is a second planet carrier 26b, and the third gearset element is a second ring gear 27b. A plurality of second planet gears 28b in meshing engagement with the second sun gear 25b and the second ring gear 27b are rotatably arranged at the second planet carrier 26b.

The first planetary gearset P1 and the second planetary gearset P2 are formed, respectively, as negative planetary gearset, the first planetary gearset P1 being arranged radially inwardly of the second planetary gearset P2. Consequently, the integral differential 7 is constructed in a radially nested manner.

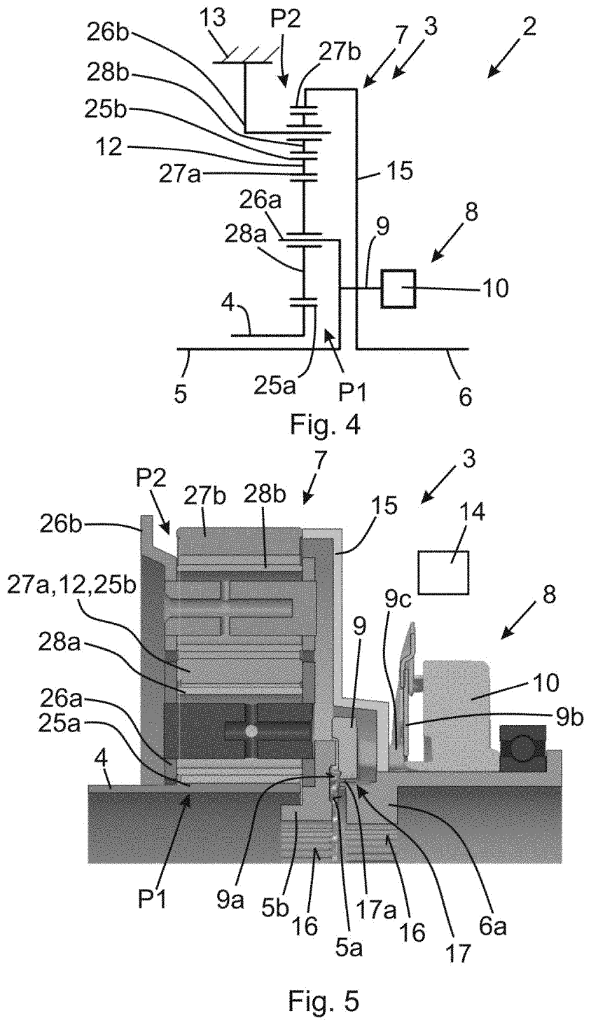

The first sun gear 25a of the first planetary gearset P1 is connected to the input shaft 4 to be fixed with respect to rotation relative to it. The first planet carrier 26a of the first planetary gearset P1 is connected to a flange 5b of the first output shaft 5 to be fixed with respect to rotation relative to it. The first output shaft 5 is connected to the flange 5b to be fixed with respect to rotation relative to it and extends axially through the input shaft 4, the first sun gear 25a and the rotor 20 of the drive unit 22 according to FIG. 2. Consequently, the first sun gear 25a is formed as an inner hollow toothed wheel and the input shaft 4 which is connected to the latter to be fixed with respect to rotation relative to it is constructed as a hollow shaft. The first ring gear 27a of the first planetary gearset P1 is connected to the second sun gear 25b of the second planetary gearset P2 to be fixed with respect to rotation relative to it via a coupling shaft 12. Consequently, the second sun gear 25b and the first ring gear 27a are formed integrally or monolithically. The second planet carrier 26b of the second planetary gearset P2 is arranged to be fixed with respect to the housing and secured to a stationary structural component 13. The second ring gear 27b of the second planetary gearset P2 is connected to the second output shaft 6 to be fixed with respect to rotation relative to it via an intermediate shaft 15 and a flange 6a. The output shafts 5, 6 are not shown in FIG. 3 and FIG. 5 but only in FIG. 1, FIG. 2 and FIG. 4. Only flanges 5b, 6a which are connected to the respective output shaft 5, 6 via an inner toothing 16 to be fixed with respect to relative rotation are shown in FIG. 3 and FIG. 5.

A first output torque is transmittable to the first output shaft 5 by the first planetary gearset P1. A reaction torque of the first planetary gearset P1 is transformable in the second planetary gearset P2 such that a second output torque corresponding to the first output torque is transmittable to the second output shaft 6.

In a pull operation of the powertrain 2, the power flow runs from the input shaft 4 at which the propulsion power of the drive unit 22 is introduced into the gear unit 3 to the two output shafts 5, 6 via the planetary gearsets P1, P2 of the integral differential 7. In a push operation of the powertrain 2, the power flow runs in the reverse direction from the respective output shaft 5, 6 via the planetary gearsets P1, P2 of the integral differential 7 to the input shaft 4, where the propulsion power is introduced into the drive unit 22. In push operation, the drive unit 22 can be operated in generator mode for generating electrical energy.

An actuation mechanism 8 having a plurality of claw-shaped positive engagement elements 9 is operatively arranged between the first output shaft 5 and the second output shaft 6, the claws or positive engagement elements 9 being formed to generate a co-rotationally fixed connection between the two output shafts 5, 6 when actuated. In this instance, the actuation mechanism 8 is an electromagnetic actuator comprising a magnet 10 which is arranged fixed with respect to the housing. In the present instance, the magnet 10 is slidingly mounted on the flange 6a of the second output shaft 6. Alternatively, the magnet 10 can also be slidingly mounted directly on the second output shaft 6 or fastened to a housing at a distance from the second output shaft 6 or the flange 6a of the second output shaft 6 so that a sliding support of the magnet 10 can be omitted.

The positive engagement elements 9 are connected to a common ring 9b having the shape of a circular disk. The positive connection elements 9 are fastened to the ring 9b via a driver 9c. Accordingly, together with the drivers 9c and the ring 9b, the positive engagement elements 9 form an integral component part which can be formed integrally or in multiple parts depending on the requirements of the component part. In every case, the individual portions or segments are connected to one another to be fixed with respect to relative rotation. To this end, the positive engagement elements 9 are supported, i.e., connected to be fixed with respect to relative rotation, in circumferential direction at the intermediate shaft 15 arranged between the second ring gear 27b and the second output shaft 6. The drivers 9c pass through the wall of the substantially radially extending portion of the intermediate shaft 15 at corresponding recesses, not shown, the drivers 9c being axially guided in the respective recess and supported in circumferential direction.

The integral component part is formed from a magnetic material in this embodiment example. Insofar as the actuation mechanism 8 is an electromechanical, hydraulic or pneumatic actuator in alternative embodiment forms which are likewise possible, the integral component part with the positive engagement elements 9 can also be formed from a different material. The actuation mechanism 8 is always formed in such a way that a positive engagement can be produced between the output shafts 5, 6 or between the flanges 5b, 6a when the actuation mechanism 8 is actuated.

In the present example, the actuation mechanism 8 in that the magnet 10 formed as electromagnet is energized and accordingly interacts with the ring 9b and the positive engagement elements 9 arranged at the latter so that the ring 9b and the positive engagement elements 9 are set in axial motion, specifically in direction of the first output shaft 5 and away from magnet 10. On a front side directed to the first output shaft 5, the positive engagement elements 9 have, in each instance, a first face toothing 9a which is adapted to come in meshing engagement with a second face toothing 5a at the flange 5b of the first output shaft 5 to form a positive engagement in circumferential direction between the output shafts 5, 6 when the actuation mechanism 8 is actuated, i.e., during the above-mentioned axial displacement of the positive engagement elements 9 in direction of the first output shaft 5. The output shafts 5, 6 are connected to one another to be fixed with respect to relative rotation as long as the magnet 10 is energized by holding current. In the present instance, the second face toothing 5a is formed at the flange 5b which is in turn connected to the first output shaft 5 shown in FIG. 2 and FIG. 4 to be fixed with respect to rotation relative to it. Alternatively, the second face toothing 5a can be formed directly on the first output shaft 5.

Further, the ring 9b is formed to interact with a sensor unit 14 in order to acquire the axial position of the ring 9b in the system. In particular, the axial position of the ring 9b relative to the magnet 10 and/or the second output shaft 6 can be determined by the sensor unit 14.

The actuation mechanism 8 has a reset mechanism 17 comprising a plurality of return springs 17a distributed at the circumference for returning the positive engagement elements 9 and the ring 9b to an initial position. The return springs 17a are arranged between the flange 5b of the first output shaft 5 and the positive engagement elements 9 and cause the positive engagement elements 9 and the ring 9b to return—in this case toward the right-hand side—to their initial position when an energization of the magnet 10 is terminated or when the magnet 10 is no longer energized.

It is explicitly noted that the association of the gearset elements with the elements of the respective planetary gearset P1, P2 can be switched in any desired manner. The respective connection of the gearset elements comprising sun gear, planet carrier and ring gear is carried out depending on the requirements for the transmission ratios, including mathematical signs. Instead of a negative planetary gearset, the respective planetary gearset P1, P2 can also always be a positive planetary gearset by switching the connection of planet carrier and ring gear and increasing the amount of the stationary gear ratio by one. The reverse is also possible in an analogous manner.

Further, it is conceivable for an additional step-up gear unit, which is not shown and which is formed, for example, as a planetary transmission with one or more planetary gearsets, to be arranged between the drive unit 22 and the gear unit 3 in order to increase the overall transmission ratio of the drive.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A gear unit for a powertrain of a vehicle, comprising:
an input shaft;
a first output shaft;
a second output shaft;
an integral differential operatively arranged between the input shaft and the first output shaft and the second output shaft,
wherein the integral differential comprises:
a first planetary gearset with a plurality of gearset elements;
a second planetary gearset with a plurality of gearset elements operatively connected to the first planetary gearset,
wherein:
a first gearset element of the first planetary gearset is connected to the input shaft to be fixed with respect to rotation relative to it;
a second gearset element of the first planetary gearset is connected to the first output shaft to be fixed with respect to rotation relative to it,
a third gearset element of the first planetary gearset is connected to a first gearset element of the second planetary gearset to be fixed with respect to rotation relative to it,
a second gearset element of the second planetary gearset is connected to a stationary structural component to be fixed with respect to rotation relative to it, and
a third gearset element of the second planetary gearset is connected to the second output shaft to be fixed with respect to rotation relative to it,
a first output torque is at least indirectly transmittable to the first output shaft by the first planetary gearset, and
a reaction torque of the first planetary gearset is converted in the second planetary gearset such that a second output torque corresponding to the first output torque is transmittable to the second output shaft; and
an actuation mechanism is operatively arranged between the first output shaft and the second output shaft and having at least one positive engagement element, wherein the at least one positive engagement element is configured to produce a co-rotationally fixed connection between the first output shaft and the second output shaft when the actuation mechanism is actuated.

2. The gear unit according to claim 1, wherein the at least one positive engagement element is a claw which is at least indirectly arranged at the second output shaft to be fixed with respect to relative rotation and axially displaceable and has a first face toothing, the claw configured to be axially displaced such that when the actuation mechanism is actuated that a first face toothing comes in meshing engagement with a second face toothing which is at least indirectly arranged at the first output shaft.

3. The gear unit according to claim 2, further comprising a plurality of positive engagement elements arranged to be distributed on a common ring.

4. The gear unit according to claim 1, wherein the actuation mechanism is an electromagnetic actuator, a hydraulic actuator, or an electromechanical actuator.

5. The gear unit according to claim 3,
wherein the claw and/or the common ring are/is a magnetic material,
wherein the actuation mechanism is an electromagnetic that magnetically interacts with the claw and/or common ring when correspondingly activated to displace the claw and/or the common ring with the claw arranged thereon in direction of the second face toothing.

6. The gear unit according to claim 5, wherein the actuation mechanism has a reset mechanism configured to reset the claw and/or the common ring to an initial position.

7. The gear unit according to claim 3, wherein the common ring is configured to interact with a sensor unit to acquire an axial position of the common ring.

8. A powertrain for a vehicle, comprising:
at least one gear unit, comprising:
an input shaft;
a first output shaft;
a second output shaft;
an integral differential operatively arranged between the input shaft and the first output shaft and the second output shaft,
wherein the integral differential comprises:
a first planetary gearset with a plurality of gearset elements;
a second planetary gearset with a plurality of gearset elements operatively connected to the first planetary gearset,
wherein:
a first gearset element of the first planetary gearset is connected to the input shaft to be fixed with respect to rotation relative to it;
a second gearset element of the first planetary gearset is connected to the first output shaft to be fixed with respect to rotation relative to it,
a third gearset element of the first planetary gearset is connected to a first gearset element of the second planetary gearset to be fixed with respect to rotation relative to it,
a second gearset element of the second planetary gearset is connected to a stationary structural component to be fixed with respect to rotation relative to it, and
a third gearset element of the second planetary gearset is connected to the second output shaft to be fixed with respect to rotation relative to it,
a first output torque is at least indirectly transmittable to the first output shaft by the first planetary gearset, and
a reaction torque of the first planetary gearset is converted in the second planetary gearset such that a second output torque corresponding to the first output torque is transmittable to the second output shaft; and
an actuation mechanism is operatively arranged between the first output shaft and the second output shaft and having at least one positive engagement element, wherein the at least one positive engagement element is configured to produce a co-rotationally fixed connection between the first output shaft and the second output shaft when the actuation mechanism is actuated; and
a drive unit which is operatively connected to the at least one gear unit.

9. The powertrain according to claim 8, wherein the drive unit is arranged coaxial to the integral differential.

10. The powertrain according to claim 8, wherein the drive unit is an electric machine and is arranged coaxial to the input shaft, wherein the first output shaft is guided through a rotor of the electric machine.
